(19) United States
(12) Patent Application Publication
(10) Pub. No.: US 2024/0296337 A1
(43) Pub. Date: Sep. 5, 2024

(54) SYSTEMS AND METHODS FOR MACHINE LEARNING TRANSFERABILITY

(71) Applicant: ADOBE INC., SAN JOSE, CA (US)

(72) Inventors: Surgan Jandial, Noida (IN); Tarun Ram Menta, Secunderabad (IN); Akash Sunil Patil, Mumbai (IN); Chirag Agarwal, Kolkata (IN); Mausoom Sarkar, Noida (IN); Balaji Krishnamurthy, Noida (IN)

(21) Appl. No.: 18/178,225

(22) Filed: Mar. 3, 2023

(51) Int. Cl. G06N 3/096

(52) U.S. Cl. CPC G06N 3/096

(57) ABSTRACT

Systems and methods for transfer learning are provided. According to one aspect, a method for transfer learning includes obtaining a target dataset, a source dataset, and a machine learning model trained on the source dataset; selecting a hard subset of the target dataset based on a similarity between the hard subset and the source dataset; computing a transferability metric for the target dataset based on the hard subset of the target dataset; and training the machine learning model using the target dataset based on the transferability metric.

### BACKGROUND

The following relates generally to transfer learning, and more specifically to machine learning transferability. Transfer learning is a machine learning technique that focuses on storing knowledge gained while solving one problem and applying the stored knowledge to a different problem, thereby minimizing an amount of training of the machine learning model for the different problem. To avoid a costly and time-consuming trial-and-error process of attempting to train a target machine learning model on a target task without knowing how easily previous knowledge learned by the target model will transfer to the new task, a transferability metric can instead be used to determine how easily source task knowledge of the target machine learning model will transfer to a target task.

However, a conventional transferability metric considers all data points in a target dataset to be equally influential in determining a transferability of source domain knowledge of a machine learning model to a target domain, which may decrease a correlation between the transferability determination provided by the conventional transferability metric and an actual accuracy of the machine learning model for the target data set. There is therefore a need in the art for machine learning transferability determination systems and methods that provide a better transferability determination.

### SUMMARY

Embodiments of the present disclosure provide systems and methods for machine learning model transferability. For example, an embodiment of the present disclosure provides a system that determines a set of hard samples included in a new dataset by comparing the new dataset against a previous dataset that has been used to train a machine learning model. The system uses the set of hard samples to compute an approximation of an accuracy of the machine learning model were the machine learning model to be trained on the new dataset.

By computing the approximation, the system avoids an expensive and time-consuming trial-and-error process of training the machine learning model based on the new dataset to evaluate the performance of the machine learning model on the new dataset. By computing the approximation based on the set of hard samples, rather than the entire new dataset, the system uses samples that most strongly correlate with the performance of the machine learning model on the new dataset, thereby increasing the quality of the approximation.

In some cases, the system trains the machine learning model on the new dataset based on the approximation. In some cases, the system uses the trained machine learning model to label input data that corresponds to the new dataset.

A method, apparatus, non-transitory computer readable medium, and system for transfer learning are described. One or more aspects of the method, apparatus, non-transitory computer readable medium, and system include obtaining a target dataset, a source dataset, and a machine learning model trained on the source dataset; selecting a hard subset of the target dataset based on a similarity between the hard subset and the source dataset; computing a transferability metric for the target dataset based on the hard subset of the target dataset; and training the machine learning model using the target dataset based on the transferability metric.

A method, apparatus, non-transitory computer readable medium, and system for transfer learning are described. One or more aspects of the method, apparatus, non-transitory computer readable medium, and system include obtaining input data in a target domain; identifying a machine learning model for the target domain, wherein the machine learning model is trained on a source dataset of a source domain and fine-tuned on a target dataset of the target domain, and wherein the machine learning model is fine-tuned based on a transferability metric computed based on a hard subset of the target dataset; and generating a label for the input data using the machine learning model.

An apparatus and system for transfer learning. One or more aspects of the apparatus and system include at least one processor; a memory storing instructions executable by the at least one processor; a selection component configured to select a hard subset of a target dataset based on a similarity between the hard subset and a source dataset used to train a machine learning model; and a transferability component configured to compute a transferability metric for the target dataset and the machine learning model based on the hard subset of the target dataset.

### BRIEF DESCRIPTION OF THE DRAWINGS

FIG. 1 shows an example of data processing system according to aspects of the present disclosure.

FIG. 2 shows an example of data processing apparatus according to aspects of the present disclosure.

FIG. 3 shows an example of data flow for determining a transferability of a machine learning model according to aspects of the present disclosure.

FIG. 4 shows an example of data flow for training a machine learning model according to aspects of the present disclosure.

FIG. 5 shows an example of data flow for labeling data according to aspects of the present disclosure.

FIG. 6 shows an example of a method for determining a transferability of a machine learning model according to aspects of the present disclosure.

FIG. 7 shows an example of a method for training a machine learning model according to aspects of the present disclosure.

FIG. 8 shows an example of a method for computing a similarity score according to aspects of the present disclosure.

FIG. 9 shows an example of a method for refraining from training an alternative machine learning model according to aspects of the present disclosure.

FIG. 10 shows an example of a method for refraining from training a machine learning model using an alternative target dataset according to aspects of the present disclosure.

FIG. 11 shows an example of a method for generating a label according to aspects of the present disclosure.

### DETAILED DESCRIPTION

Embodiments of the present disclosure relate generally to transfer learning, and more specifically to machine learning transferability. Transfer learning is a machine learning technique that focuses on storing knowledge gained while solving one problem and applying the stored knowledge to a different problem, thereby minimizing an amount of training of the machine learning model for the different problem.

To avoid a costly and time-consuming trial-and-error process of attempting to train a pre-trained machine learning model on a new task without knowing how well previous knowledge learned by the pre-trained machine learning model will transfer to the new task, a transferability metric can instead be used to determine how easily source task knowledge of the pre-trained machine learning model will transfer to the new task.

For example, given a source task represented by a labeled data set or a pre-trained model, and a target task, represented by a labeled data set, a transferability metric can be determined to quantify, without training on the target task, how effectively a transfer learning algorithm can transfer knowledge from the source task to the target task.

However, computing a conventional transferability metric often involves performing a transfer learning task for parameter optimization, or making strong assumptions on source/target datasets. For example, conventional transferability metrics consider all data points in a target dataset to be equally influential in determining a transferability of source domain knowledge to a target domain, which may decrease a correlation between the transferability determination provided by the conventional transferability metric and an actual accuracy of the machine learning model for the target data set. Further, conventional transferability metrics can be limited to estimating transferability on specific source architectures and can be inaccurate with respect to noisy and imbalanced datasets.

According to some aspects, a data processing system is provided. In some cases, the data processing system includes a selection component and a transferability component. In some cases, the selection component is configured to select a hard subset of a target dataset based on a similarity between the hard subset and a source dataset used to train a machine learning model. In some cases, the transferability component is configured to compute a transferability metric for the target dataset and the machine learning model based on the hard subset of the target dataset.

By selecting the hard subset of data, the selection component identifies data of the target dataset that is more relevant in determining a transferability metric for the machine learning model than the remaining data in the target dataset, thereby increasing a correlation of the transferability metric computed based on the hard dataset with an accuracy of the machine learning model's predictions if the machine learning model were to be trained and evaluated on the target dataset. In other words, using the hard subset of the target dataset, rather than the entire target dataset, for determining the transferability metric results in a better transferability metric than conventional systems provide. Accordingly, by selecting the hard subset and determining the transferability metric based on the hard subset, a data processing system having an increased transferability determination performance over conventional data processing systems is provided.

Furthermore, according to some aspects, the data processing system further includes a training component configured to train the machine learning model using the target dataset based on the transferability metric. The transferability metric allows the data processing system to make a confident determination that it is worthwhile to train the machine learning model on the target dataset. In some cases, the transferability metric allows the data processing system to determine that is not worthwhile to train a different machine learning model on the target dataset or to train the machine learning model on a different target dataset. Furthermore, in some cases, the transferability metric allows the data processing system to determine a best machine learning model to be trained for a given target dataset. Accordingly, by training the machine learning model based on the transferability metric, the training component avoids training multiple machine learning models on multiple target datasets in a lengthy and computationally expensive trial-and-error process.

According to some aspects, the data processing system further includes a classification component configured to generate a label for input data in a target domain using a machine learning model trained on a source data from a source domain and fine-tuned on target data from the target domain. In some cases, the machine learning model is fine-tuned by the training component based on the transferability metric. Accordingly, in some cases, the data processing system determines a suitability for transferring a machine learning model to a target task, fine-tunes the machine learning model based on the determination, and uses the fine-tuned machine learning model to classify input data at inference time, thereby offering a more streamlined transfer learning process than a comparative system that relies on trial-and-error determination or a lower-quality transferability metric.

An example of the data processing system is used in a data labeling context. In the example, a user wants to label a set of images using machine learning but does not have a machine learning model that has been trained on a target dataset corresponding to the set of images (for example, a target dataset including image-caption pairs, where the images of the image-caption pairs depict similar objects as the set of images). The user can avoid the time and expense of training a machine learning model to label the set of images from scratch by taking advantage of transfer learning. For example, a pre-trained machine learning model can be selected that has been trained on a different dataset, and can be fine-tuned to label the set of images.

In the example, the data processing system optimizes the selection of an appropriate machine learning model. For example, the data processing system identifies a target dataset that corresponds to the set of images. The data processing system determines a hard subset of the target dataset by comparing the target dataset with a source dataset that was used to train the machine learning model. The data processing system then computes a transferability metric for the target dataset based on the hard subset. The transferability metric quantifies how well the machine learning model would perform if it were to be fine-tuned based on the target dataset.

In some cases, the data processing system computes a group of hard subsets by comparing the target dataset to a group of source datasets respectively corresponding to a group of machine learning models that are respectively trained on source datasets of the group of source datasets, and computes a transferability metric corresponding to each of the group of machine learning models based on the respective hard subsets.

The data processing system selects a machine learning model of the group of machine learning models that corresponds to a greatest transferability metric and fine-tunes the selected machine learning model on the target dataset in response to the selection. The data processing system then uses the fine-tuned machine learning model to label a sample from the set of images and provides the label to the user.

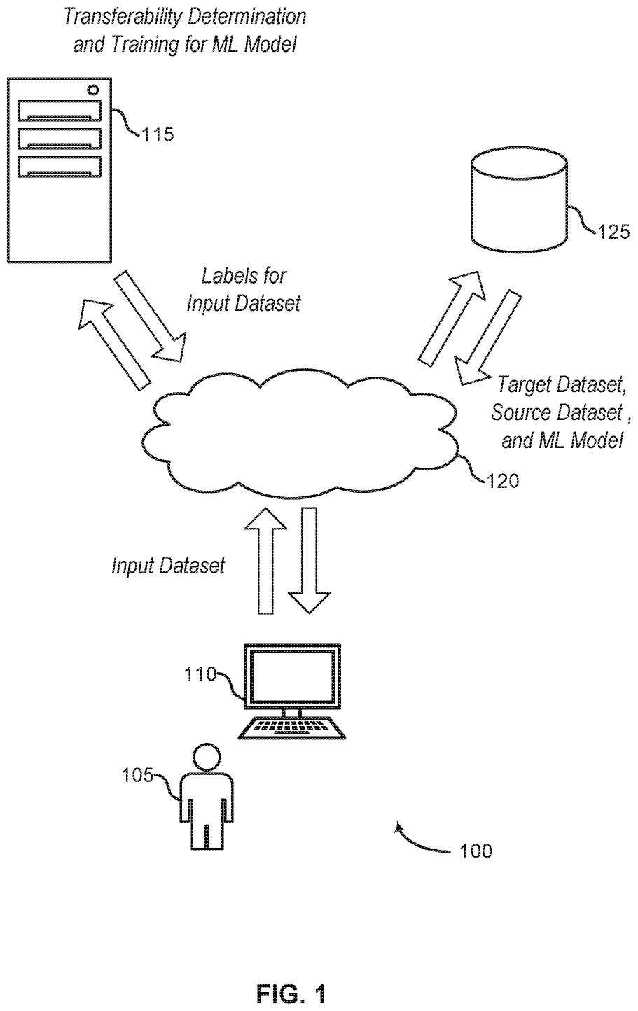

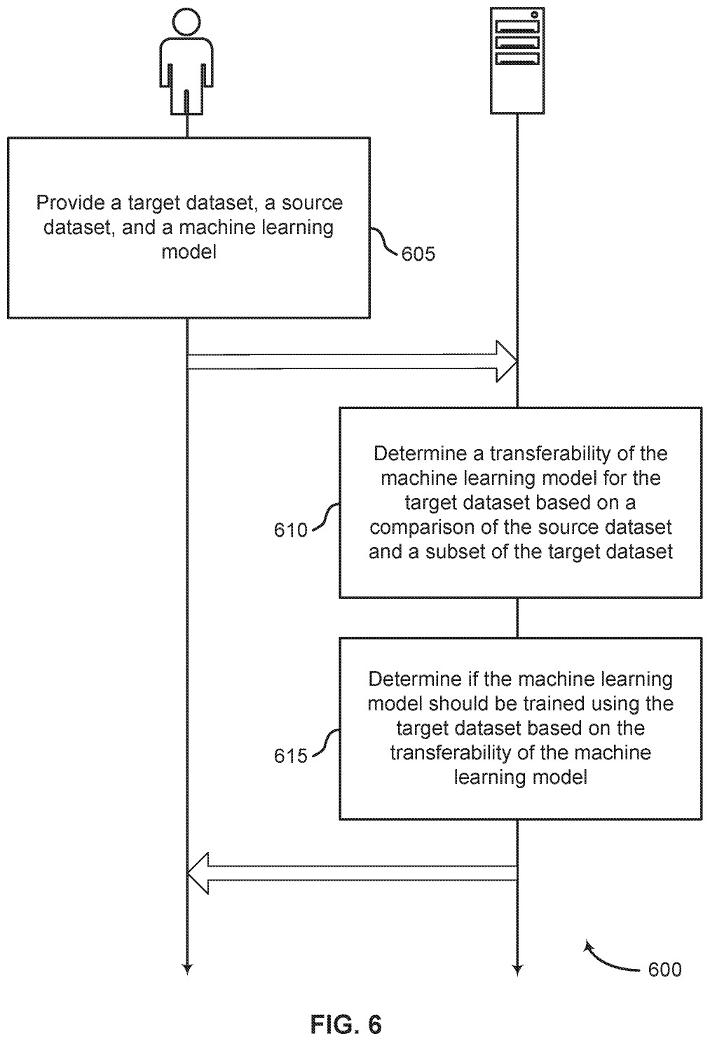

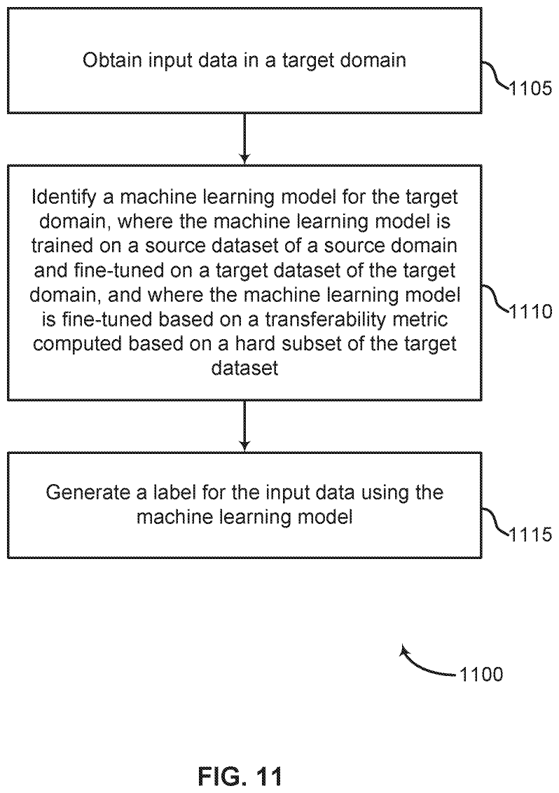

Further example applications of the data processing system in a classification context are provided with reference to FIGS. 1 and 11. Further example applications of the data processing system in a training determination context are provided with reference to FIGS. 1, 6, 7, and 11. Examples of a process for training a machine learning model are described with reference to FIGS. 6-10. Examples of a process for labeling input data are provided with reference to FIG. 11.

### Data Processing System

A data processing system and apparatus is described with reference to FIGS. 1-5. One or more aspects of the system and apparatus include at least one processor; a memory storing instructions executable by the at least one processor; a selection component configured to select a hard subset of a target dataset based on a similarity between the hard subset and a source dataset used to train a machine learning model; and a transferability component configured to compute a transferability metric for the target dataset and the machine learning model based on the hard subset of the target dataset.

Some examples of the system and apparatus further include a training component configured to train the machine learning model using the target dataset based on the transferability metric. Some examples the system and apparatus further include a database configured to store the target dataset and the source dataset.

FIG. 1 shows an example of data processing system 100 according to aspects of the present disclosure. The example shown includes user 105, user device 110, data processing apparatus 115, cloud 120, and database 125.

Referring to FIG. 1, an example of data processing apparatus 115 is used in a data labeling context. In the example, user 105 wants to label an input dataset using machine learning but does not have a machine learning model that has been trained to make predictions for the data included in the input dataset. User 105 can save the time and expense involved in training a machine learning model for the input dataset from scratch by selecting a pre-trained machine learning model that has been trained for a different prediction task on a source dataset, and transferring the knowledge gained by the pre-trained machine learning model on the source dataset to a target dataset.

User 105 provides the input dataset to data processing apparatus 115 via user device 110. Data processing apparatus 115 retrieves a similar target training dataset from database 125. Data processing apparatus 115 optimizes the selection of an appropriate machine learning model for transfer learning by determining a hard subset of the target dataset as compared with a source dataset retrieved from database 125 and computing a transferability metric for the machine learning model based on the hard subset. The transferability metric quantifies how well the machine learning model would perform if the machine learning model were to be fine-tuned based on the target dataset.

By computing the transferability metric based on the hard subset, rather than the entire target dataset, data processing apparatus 115 increases a correlation between the transferability metric and an accuracy of the machine learning model were the machine learning model to be trained on the target dataset, thereby providing a better transferability metric than conventional data processing systems.

Data processing apparatus 115 retrieves a machine learning model corresponding to the transferability metric from the database 125 and fine-tunes the pre-trained machine learning model on the target dataset in response to the selection. In some cases, data processing apparatus 115 computes multiple transferability metrics for multiple machine learning models, and retries a machine learning model from database 125 that corresponds to a greatest transferability metric. The data processing system then uses the fine-tuned machine learning model to label a sample from the input dataset and provides the label to user 105 via user device 110.

According to some aspects, user device 110 is a personal computer, laptop computer, mainframe computer, palmtop computer, personal assistant, mobile device, or any other suitable processing apparatus. In some examples, user device 110 includes software, such as a graphical user interface, that displays and facilitates the communication of information, such as a dataset, a transferability metric, and/or a label for data, between user 105 and data processing apparatus 115.

According to some aspects, a user interface enables user 105 to interact with user device 110. In some embodiments, the user interface may include an audio device, such as an external speaker system, an external display device such as a display screen, or an input device (e.g., a remote-control device interfaced with the user interface directly or through an IO controller module). In some cases, the user interface may be a graphical user interface (GUI).

According to some aspects, data processing apparatus 115 includes a computer implemented network. In some embodiments, the computer implemented network includes a machine learning model. In some embodiments, data processing apparatus 115 also includes one or more processors, a memory subsystem, a communication interface, an I/O interface, one or more user interface components, and a bus. Additionally, in some embodiments, data processing apparatus 115 communicates with user device 110 and database 125 via cloud 120.

In some cases, data processing apparatus 115 is implemented on a server. A server provides one or more functions to users linked by way of one or more of various networks, such as cloud 120. In some cases, the server includes a single microprocessor board that includes a microprocessor responsible for controlling all aspects of the server. In some cases, the server uses a microprocessor and a protocol, such as hypertext transfer protocol (HTTP), simple mail transfer protocol (SMTP), file transfer protocol (FTP), simple network management protocol (SNMP), or the like, to exchange data with other devices or users on one or more of the networks. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

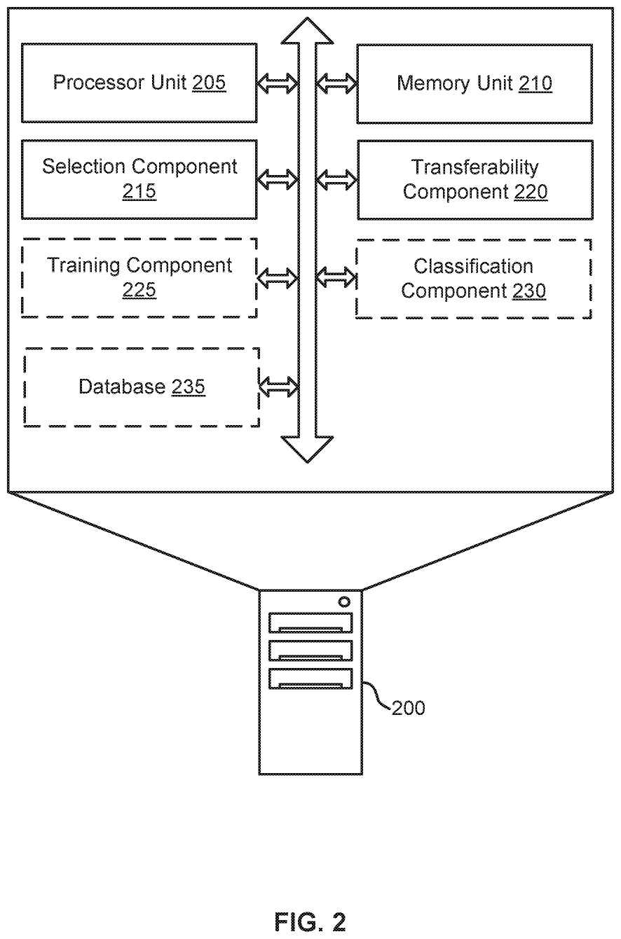

Data processing apparatus 115 is an example of, or includes aspects of, the corresponding element described with reference to FIGS. 2-5. Further detail regarding the architecture of data processing apparatus 115 is provided with reference to FIGS. 2-5. Further detail regarding a process for training a machine learning model are described with reference to FIGS. 6-10. Further detail regarding a process for labeling input data are provided with reference to FIG. 11.

Cloud 120 is a computer network configured to provide on-demand availability of computer system resources, such as data storage and computing power. In some examples, cloud 120 provides resources without active management by user 105. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, data processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to data processing apparatus 115 and communicates with data processing apparatus 115 via cloud 120. According to some aspects, database 125 is included in data processing apparatus 115. According to some aspects, database 125 is configured to store the target dataset and the source dataset.

According to some aspects, database 125 stores a source dataset, a target dataset, a machine learning model, a hard subset, a transferability metric, an intermediate target embedding, an intermediate source embedding, a plurality of intermediate target embeddings, a plurality of intermediate source embeddings, a similarity score, a hardness score, a pairwise similarity activation matrix, a transferability threshold, an alternative source dataset, an alternative machine learning model, an alternative hard subset, an alternative transferability metric, an alternative target dataset, input data, a label, a fine-tuned machine learning model, or a combination thereof. In some cases, database 125 stores a parameter for the machine learning model, for the fine-tuned machine learning model, or for a combination thereof.

FIG. 2 shows an example of data processing apparatus 200 according to aspects of the present disclosure. Data processing apparatus 200 is an example of, or includes aspects of, the corresponding element described with reference to FIGS. 1 and 3-5. In one aspect, data processing apparatus 200 includes processor unit 205, memory unit 210, selection component 215, transferability component 220, training component 225, classification component 230, and database 235.

According to some aspects, processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 205 is configured to operate a memory array using a memory controller. In other cases, the memory controller is integrated into processor unit 205. In some cases, processor unit 205 is configured to execute computer-readable instructions stored in memory unit 210 to perform various functions. In some embodiments, processor unit 205 includes special-purpose components for modem processing, baseband processing, digital signal processing, or transmission processing.

According to some aspects, memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 205 to perform various functions described herein. In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

According to some aspects, selection component 215 obtains a target dataset, a source dataset, and a machine learning model trained on the source dataset. According to some aspects, the machine learning model includes one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

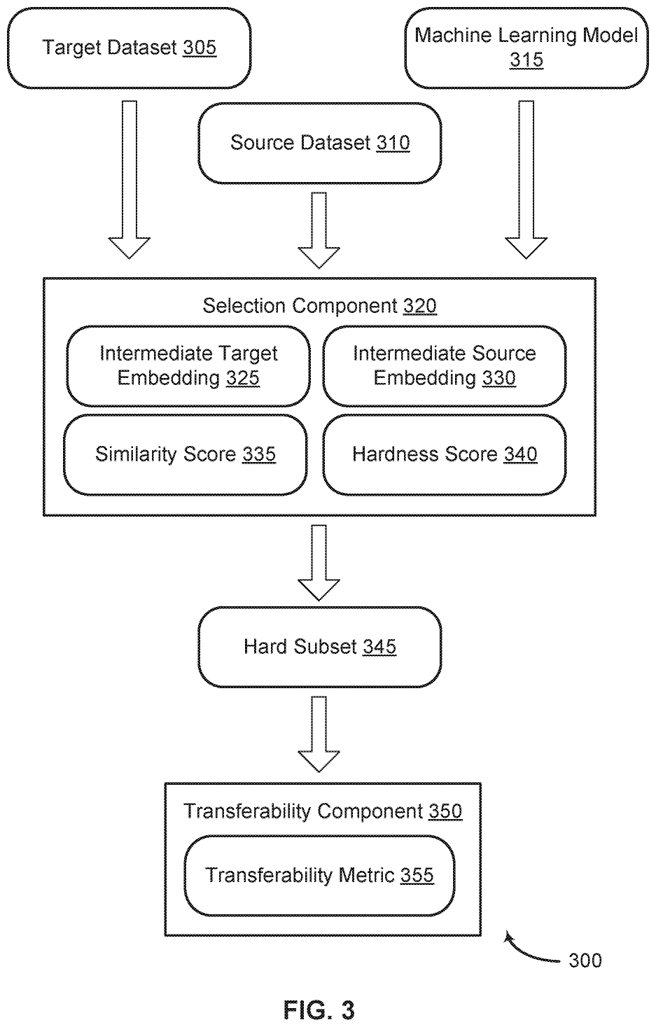

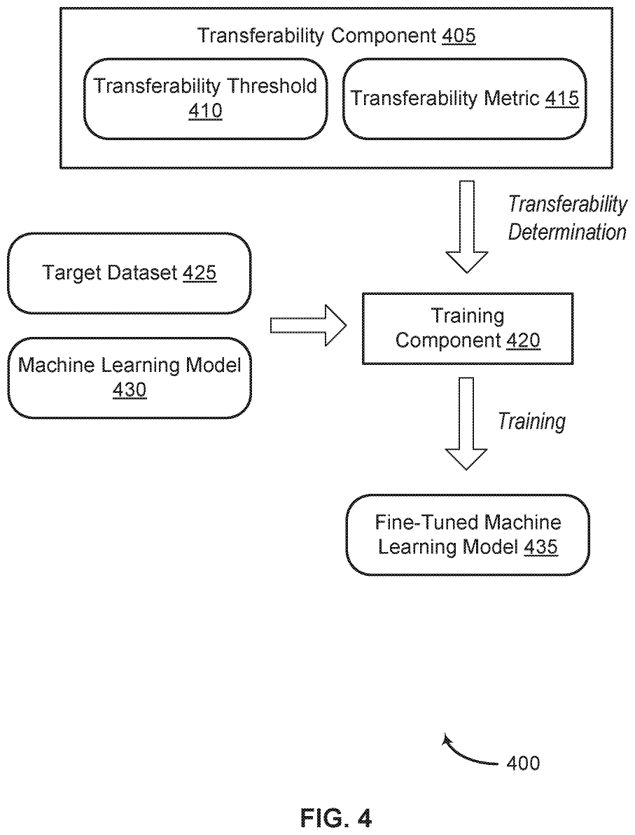

The machine learning model is an example of, or includes aspects of, the corresponding element described with reference to FIGS. 3 and 4. According to some aspects, the machine learning model is implemented in data processing apparatus 200 as one or more hardware circuits, as firmware, as software stored in memory unit 210 and executed by processor unit 205, or as a combination thereof. According to some aspects, the machine learning model is implemented as data stored in a database (such as the database described with reference to FIG. 1) and retrieved by data processing apparatus, where the data is implemented by one or more hardware circuits, as firmware, as software stored in memory unit 210 and executed by processor unit 205, or a combination thereof to perform the functions described herein. According to some aspects, the machine learning model or the data for the machine learning model is provided to data processing apparatus 200 by a user.

In some examples, selection component 215 selects a hard subset of the target dataset based on a similarity between the hard subset and the source dataset. In some aspects, the target dataset represents a different domain than the source dataset.

In some examples, selection component 215 computes an intermediate target embedding for a sample of the target dataset using the machine learning model. In some examples, selection component 215 computes an intermediate source embedding for a sample of the source dataset using the machine learning model. In some examples, selection component 215 computes a similarity score based on the intermediate target embedding and the intermediate source embedding, where the hard subset is selected based on the similarity score. In some examples, selection component 215 computes a set of intermediate target embeddings at a set of layers of the machine learning model, where the similarity score is based on the set of intermediate target embeddings.

In some examples, selection component 215 computes a hardness score for each sample of the target dataset, where the hard subset is selected based on the hardness score. In some examples, selection component 215 calculates a pairwise activation similarity matrix between a set of target samples of the target dataset and a set of source samples of the source dataset, where the hardness score is based on the pairwise activation similarity matrix. In some examples, selection component 215 sorts the target dataset into a set of non-overlapping bins. In some examples, selection component 215 selects the hard subset based on the set of non-overlapping bins.

In some examples, selection component 215 obtains an alternative source dataset and an alternative machine learning model trained on the alternative source dataset. In some examples, selection component 215 selects an alternative hard subset of the target dataset based on a similarity between the hard subset and the alternative source dataset. In some examples, selection component 215 obtains an alternative target dataset. In some examples, selection component 215 selects an alternative hard subset of the alternative target dataset based on a similarity between the alternative hard subset and the source dataset.

According to some aspects, selection component 215 is configured to select a hard subset of a target dataset based on a similarity between the hard subset and a source dataset used to train a machine learning model.

Selection component 215 is an example of, or includes aspects of, the corresponding element described with reference to FIG. 3. According to some aspects, selection component 215 is implemented in data processing apparatus 200 as one or more hardware circuits, as firmware, as software stored in memory unit 210 and executed by processor unit 205, or as a combination thereof.

According to some aspects, transferability component 220 computes a transferability metric for the target dataset based on the hard subset of the target dataset. In some examples, transferability component 220 determines that the transferability metric is greater than a transferability threshold, where the machine learning model is trained using the target dataset based on the determination. In some examples, transferability component 220 computes an alternative transferability metric for the target dataset based on the alternative hard subset of the target dataset. In some examples, transferability component 220 computes an alternative transferability metric for the alternative target dataset based on the alternative hard subset of the alternative target dataset.

Transferability component 220 is an example of, or includes aspects of, the corresponding element described with reference to FIGS. 3 and 4. According to some aspects, transferability component 220 is implemented in data processing apparatus 200 as one or more hardware circuits, as firmware, as software stored in memory unit 210 and executed by processor unit 205, or as a combination thereof.

According to some aspects, training component 225 trains the machine learning model using the target dataset based on the transferability metric. In some examples, training component 225 refrains from training the alternative machine learning model using the target dataset based on the alternative transferability metric. In some examples, training component 225 refrains from training the machine learning model using the alternative target dataset based on the alternative transferability metric.

According to some aspects, training component 225 is configured to train the machine learning model using the target dataset based on the transferability metric. According to some aspects, training component 225 is configured to fine-tune the machine learning model on a target dataset of the target domain. According to some aspects, training component 225 is configured to fine-tune the machine learning model based on the transferability metric.

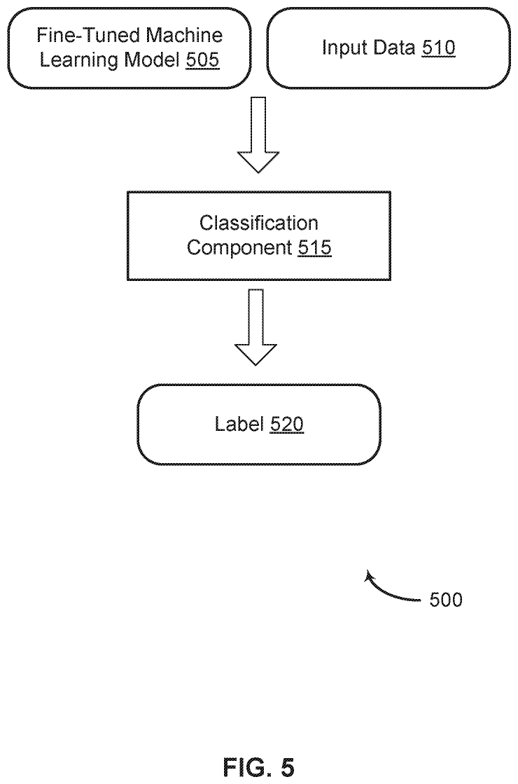

Training component 225 is an example of, or includes aspects of, the corresponding element described with reference to FIGS. 4 and 5. According to some aspects, training component 225 is implemented in data processing apparatus 200 as one or more hardware circuits, as firmware, as software stored in memory unit 210 and executed by processor unit 205, or as a combination thereof.

According to some aspects, training component 225 is omitted from data processing apparatus 200 and included in a different apparatus to perform the functions described herein. In some cases, the different apparatus communicates with data processing apparatus 200 to perform the functions described herein. According to some aspects, training component 225 is implemented in the different apparatus as one or more hardware circuits, as firmware, as software stored in a memory and executed by a processor, or as a combination thereof.

According to some aspects, classification component 230 obtains input data in a target domain. In some examples, classification component 230 identifies a machine learning model for the target domain, where the machine learning model is trained on a source dataset of a source domain and fine-tuned on a target dataset of the target domain, and where the machine learning model is fine-tuned based on a transferability metric computed based on a hard subset of the target dataset. According to some aspects, classification component 230 generates a label for the input data using the machine learning model.

Classification component 230 is an example of, or includes aspects of, the corresponding element described with reference to FIG. 5. According to some aspects, classification component 230 is implemented in data processing apparatus 200 as one or more hardware circuits, as firmware, as software stored in memory unit 210 and executed by processor unit 205, or as a combination thereof. According to some aspects, classification component 230 is omitted from data processing apparatus 200.

According to some aspects, database 235 is configured to store the source dataset, the target dataset, the machine learning model, the hard subset, the transferability metric, the intermediate target embedding, the intermediate source embedding, the plurality of intermediate target embeddings, a plurality of intermediate source embeddings, the similarity score, the hardness score, the pairwise similarity activation matrix, the transferability threshold, the alternative source dataset, the alternative machine learning model, the alternative hard subset, the alternative transferability metric, the alternative target dataset, the input data, the label, the fine-tuned machine learning model, or a combination thereof. Database 235 is an example of, or includes aspects of, the corresponding element described with reference to FIG. 1. In some cases, database 235 is omitted from data processing apparatus 200 and is included in a different apparatus to provide the functions described herein.

FIG. 3 shows an example of data flow in a data processing apparatus 300 for determining a transferability of a machine learning model according to aspects of the present disclosure. The example shown includes data processing apparatus 300, target dataset 305, source dataset 310, machine learning model 315, selection component 320, intermediate target embedding 325, intermediate source embedding 330, similarity score 335, hardness score 340, hard subset 345, transferability component 350, and transferability metric 355.

Data processing apparatus 300 is an example of, or includes aspects of, the corresponding element described with reference to FIGS. 1-2 and 4-5. Machine learning model 315 is an example of, or includes aspects of, the corresponding element described with reference to FIGS. 2 and 4. Selection component 320 is an example of, or includes aspects of, the corresponding element described with reference to FIG. 2. Transferability component 350 is an example of, or includes aspects of, the corresponding element described with reference to FIGS. 2 and 4. Transferability metric 355 is an example of, or includes aspects of, the corresponding element described with reference to FIG. 4.

In the example shown by FIG. 3, selection component 320 obtains target dataset 305, source dataset 310, and machine learning model 315 from a database (such as the database described with reference to FIGS. 1 and 2), a user device (such as the user device described with reference to FIG. 1), or a combination thereof. In some cases, machine learning model 315 is trained on source dataset 310.

Selection component 320 computes intermediate target embedding 325 for each sample of target dataset 305 using machine learning model 315, computes intermediate source embedding 330 for each sample of source dataset 310 using machine learning model 315, and computes similarity score 335 based on intermediate target embedding 325 and intermediate source embedding 330. Source embedding computes hardness score 340 for each sample of target dataset 305 based on similarity score 335. Selection component 320 selects hard subset 345 from target dataset 305 based on hardness score 340 and provides hard subset 345 to transferability component 350. Transferability component 350 computes transferability metric 355 for target dataset 305 based on hard subset 345.

FIG. 4 shows an example of data flow in a data processing apparatus 400 for training a machine learning model according to aspects of the present disclosure. The example shown includes data processing apparatus 400, transferability component 405, transferability threshold 410, transferability metric 415, training component 420, target dataset 425, machine learning model 430, and fine-tuned machine learning model 435.

Data processing apparatus 400 is an example of, or includes aspects of, the corresponding element described with reference to FIGS. 1-3 and 5. Transferability component 405 is an example of, or includes aspects of, the corresponding element described with reference to FIGS. 2 and 3. Transferability metric 415 is an example of, or includes aspects of, the corresponding element described with reference to FIG. 3. Training component 420 is an example of, or includes aspects of, the corresponding element described with reference to FIG. 2. Target dataset 425 is an example of, or includes aspects of, the corresponding element described with reference to FIG. 3. Machine learning model 430 is an example of, or includes aspects of, the corresponding element described with reference to FIGS. 2 and 3. Fine-tuned machine learning model 435 is an example of, or includes aspects of, the corresponding element described with reference to FIGS. 2 and 5.

In the example shown by FIG. 4, transferability component 405 determines that transferability metric 415 (received from the selection component as described with reference to FIG. 3) is greater than transferability threshold 410 and provides the determination to training component 420 (for example, by providing a signal indicating the determination). Based on the determination, training component 420 obtains target dataset 425 and machine learning model 430 (for example, from the database, the user device, or the selection component as described with reference to FIG. 3) and trains machine learning model 430 using target dataset 425. In some cases, the training includes fine-tuning or re-training a head of the machine learning model. As shown in FIG. 4, the training is a fine-tuning process, and training component 420 obtains fine-tuned machine learning model 435 by fine-tuning machine learning model 430 on target dataset 425. According to some aspects, training component 420 stores fine-tuned machine learning model 435, or data corresponding to fine-tuned machine learning model 435 (such as parameters) to a database (such as the database described with reference to FIGS. 1 and 2).

FIG. 5 shows an example of data flow in a data processing apparatus 500 for labeling data according to aspects of the present disclosure. The example shown includes data processing apparatus 500, fine-tuned machine learning model 505, input data 510, classification component 515, and label 520.

Data processing apparatus 500 is an example of, or includes aspects of, the corresponding element described with reference to FIGS. 1-4. Fine-tuned machine learning model 505 is an example of, or includes aspects of, the corresponding element described with reference to FIGS. 2 and 4. Classification component 515 is an example of, or includes aspects of, the corresponding element described with reference to FIG. 2.

In the example shown by FIG. 5, classification component 515 obtains fine-tuned machine learning model 505 (for example, from a training component such as the training component described with reference to FIG. 4, or a database such as the database described with reference to FIGS. 1 and 2) and input data 510 (for example, from the database or from a user device such as the user device described with reference to FIG. 1) and uses fine-tuned machine learning model 505 to generate label 520 for a sample of input data 510. In some cases, classification component 515 selects fine-tuned machine learning model 505 based on a domain of input data 510 from a set of fine-tuned machine learning models stored in the database.

### Transferability Determination

A transfer learning method is described with reference to FIGS. 6-10. One or more aspects of the method include obtaining a target dataset, a source dataset, and a machine learning model trained on the source dataset; selecting a hard subset of the target dataset based on a similarity between the hard subset and the source dataset; computing a transferability metric for the target dataset based on the hard subset of the target dataset; and training the machine learning model using the target dataset based on the transferability metric. In some aspects, the target dataset represents a different domain than the source dataset.

Some examples of the method further include computing an intermediate target embedding for a sample of the target dataset using the machine learning model. Some examples further include computing an intermediate source embedding for a sample of the source dataset using the machine learning model. Some examples further include computing a similarity score based on the intermediate target embedding and the intermediate source embedding, wherein the hard subset is selected based on the similarity score. Some examples of the method further include computing a plurality of intermediate target embeddings at a plurality of layers of the machine learning model, wherein the similarity score is based on the plurality of intermediate target embeddings.

Some examples of the method further include computing a hardness score for each sample of the target dataset, wherein the hard subset is selected based on the hardness score. Some examples of the method further include calculating a pairwise activation similarity matrix between a plurality of target samples of the target dataset and a plurality of source samples of the source dataset, wherein the hardness score is based on the pairwise activation similarity matrix. Some examples of the method further include sorting the target dataset into a plurality of non-overlapping bins. Some examples further include selecting the hard subset based on the plurality of non-overlapping bins.

Some examples of the method further include determining that the transferability metric is greater than a transferability threshold, wherein the machine learning model is trained using the target dataset based on the determination.

Some examples of the method further include obtaining an alternative source dataset and an alternative machine learning model trained on the alternative source dataset. Some examples further include selecting an alternative hard subset of the target dataset based on a similarity between the hard subset and the alternative source dataset. Some examples further include computing an alternative transferability metric for the target dataset based on the alternative hard subset of the target dataset. Some examples further include refraining from training the alternative machine learning model using the target dataset based on the alternative transferability metric.

Some examples of the method further include obtaining an alternative target dataset. Some examples further include selecting an alternative hard subset of the alternative target dataset based on a similarity between the alternative hard subset and the source dataset. Some examples further include computing an alternative transferability metric for the alternative target dataset based on the alternative hard subset of the alternative target dataset. Some examples further include refraining from training the machine learning model using the alternative target dataset based on the alternative transferability metric.

FIG. 6 shows an example of a method 600 for determining a transferability of a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, an example of the data processing apparatus described with reference to FIGS. 1-3 is used to determine a transferability of a machine learning model from a source dataset to a target dataset. By determining a transferability metric for the machine learning model, the data processing apparatus efficiently provides a numerical representation for how well the machine learning model would perform on the target dataset if it were to be trained (e.g., fine-tuned) on the target dataset. The transferability metric thereby avoids an expensive and time-consuming trial and error process of training the machine learning model on the target dataset to determine the accuracy.

A hard subset of a target dataset can most strongly correlate with an accuracy of a given transfer learning task. Therefore, by determining the transferability metric based on the hard subset, the data processing apparatus provides a transferability metric that has a higher correlation with the accuracy of the machine learning model for the target dataset than conventional data processing systems provide, because conventional data processing systems use the entire target dataset to determine a comparative transferability metric, which introduces error. In other words, in some cases, the transferability metric based on the hard subset is a better representation of an accuracy of a machine learning model for a transferred learning task than a comparative transferability metric.

At operation 605, a user provides a target dataset, a source dataset, and a machine learning model to the data processing apparatus. In some cases, the operations of this step refer to, or may be performed by, a user as described with reference to FIG. 1. For example, the user provides the target dataset, the source dataset, and the machine learning model to the data processing apparatus via a user device (such as the user device described with reference to FIG. 1).

In an example, the machine learning model is trained on the source dataset to classify images corresponding to a class of objects in the source dataset. In an example, the source dataset can include images of bicycles, and the machine learning model is trained to classify images of bicycles that are provided as input to the machine learning image. The target dataset can include images relating to a different class, such as images of cats. In this case, one goal of a transferability metric is providing a numerical representation of how well the machine learning model's knowledge of bicycle classification would transfer to a task of labeling a cat in an input image if the machine learning model were to be fine-tuned on the target dataset.

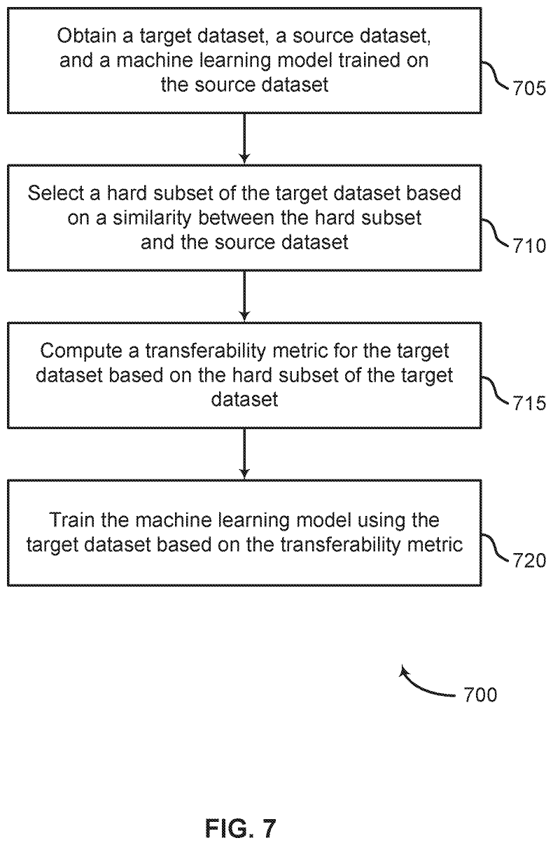

At operation 610, the system determines a transferability of the machine learning model for the target dataset based on a comparison of the source dataset and a subset of the target dataset. In some cases, the operations of this step refer to, or may be performed by, a data processing apparatus as described with reference to FIGS. 1-5. For example, in some cases, the data processing apparatus computes a transferability metric for the machine learning model as described with reference to FIG. 7. In an example, the data processing apparatus determines a transferability metric for the machine learning model trained on bicycles if the machine learning model were to be trained to label images of cats that corresponds to the actual accuracy of the machine learning model were it to be trained accordingly.

At operation 615, the system determines if the machine learning model should be trained using the target dataset based on the transferability of the machine learning model. In some cases, the operations of this step refer to, or may be performed by, a data processing apparatus as described with reference to FIGS. 1-5.

For example, in some cases, the data processing apparatus compares the transferability metric against a transferability threshold as described with reference to FIG. 7, where the determination is based on the comparison. In some cases, the data processing apparatus provides the transferability metric, the transferability threshold, the determination, or a combination thereof to the user (for example, via a message generated by the data processing apparatus and provided to the user device that includes relevant information). In some cases, the data processing apparatus proceeds to train the machine learning model on the training dataset based on the determination without instruction from the user. In some cases, the data processing apparatus proceeds to train the machine learning model on the training dataset based on instruction from the user.

In an example, the data processing apparatus determines that the transferability metric for the machine learning model and the target dataset is sufficient because the transferability metric exceeds a transferability threshold. In response to the determination, the data processing apparatus may recommend to the user, via a user interface (e.g. a graphic user interface, etc.), to fine-tune the machine learning model based on the target dataset to perform the task of labelling images of cats. The data processing apparatus can automatically proceed to fine-tune the machine learning model, or can wait for instruction from the user.

FIG. 7 shows an example of a method 700 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 7, an example of a data processing apparatus described with reference to FIGS. 1-4 determines, based on a transferability metric computed using a hard subset of a target dataset, to train a machine learning model on the target dataset, and trains the machine learning model based on the determination.

By determining a transferability metric for the machine learning model, the data processing apparatus provides a numerical representation for how well the machine learning model would perform on the target dataset if it were to be trained (e.g., fine-tuned) on the target dataset. The transferability metric thereby avoids an expensive and time-consuming trial and error process of training the machine learning model on the target dataset to determine the accuracy.

By determining the transferability metric based on a hard subset of the target dataset, the data processing apparatus provides a transferability metric that has a higher correlation with the accuracy of the machine learning model for the target dataset than conventional data processing systems provide, because conventional data processing systems use the entire target dataset to determine a comparative transferability metric, which introduces error. In other words, in some cases, the transferability metric is a better representation of an accuracy of a machine learning model for a transferred learning task than comparative transferability metrics.

At operation 705, the system obtains a target dataset [symbol] ₜ={(x₁^{t}, y₁^{t}), (x₂^{t}, y₂^{t}), . . . , (xₘ^{t}, yₘ^{t})}, a source dataset [symbol] ₛ={(x₁^{s}, y₁^{s}), (x₂^{s}, y₂^{s}), . . . , (xₙ^{s}, yₙ^{s})}, and a machine learning model f_{θ}^{s} trained on the source dataset [symbol] ₛ. In some cases, the operations of this step refer to, or may be performed by, a selection component as described with reference to FIGS. 2 and 3.

In some cases, the selection component obtains the target dataset [symbol] ₜ, the source dataset [symbol] ₛ, and the machine learning model f_{θ}^{s} from a user (such as the user described with reference to FIG. 1), a database (such as the database described with reference to FIGS. 1-2), another data source, or a combination thereof. As used herein, a “dataset” refers to a collection of data. In some cases, an individual item of data within a dataset is referred to as a “sample”. As used herein, a “source dataset” refers to a dataset that the machine learning model has already been trained on. As used herein, a “target dataset” refers to a dataset that the machine learning model may be trained on. In some cases, “training” using the target dataset [symbol] ₜ refers to re-training and/or fine-tuning the machine learning model f_{θ}^{s} on the target dataset [symbol] ₜ.

According to some aspects, the target dataset [symbol] ₜ represents a different domain than the source dataset [symbol] ₛ. In machine learning, in some cases, a “domain” refers to a set of values that a function can take. Therefore, in some cases, the source dataset [symbol] ₛ represents a different set of values than the target dataset [symbol] ₜ.

At operation 710, the system selects a hard subset [symbol] _{H} of the target dataset [symbol] ₜ based on a similarity between the hard subset [symbol] _{H} and the source dataset [symbol] ₛ. In some cases, the operations of this step refer to, or may be performed by, a selection component as described with reference to FIGS. 2 and 3.

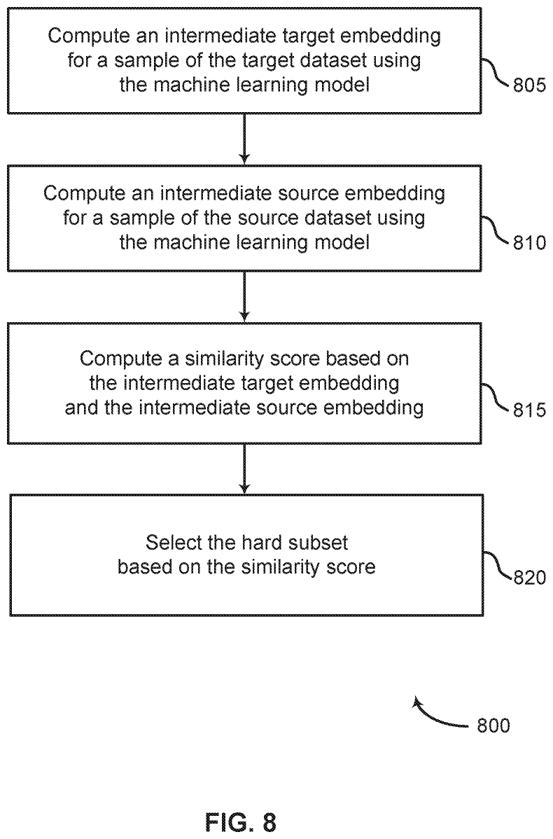

According to some aspects, the selection component computes a similarity score s(xᵢ^{s}, xᵢ^{t}) as described with reference to FIG. 8, where the hard subset [symbol] _{H} is selected based on the similarity score s(xᵢ^{s}, xᵢ^{t}).

According to some aspects, the selection component computes a hardness score H(xᵢ^{t}) for a sample xᵢ^{t} of the target dataset [symbol] ₜ:

$$H ( {x}_{i}^{t} ) = \frac{1}{m} {\sum }_{j = 1}^{m} S ( {x}_{j}^{s} , {x}_{i}^{t} ) \qquad ( 1 )$$

In some cases, m is the number of samples in the source dataset [symbol] ₛ and S is the pairwise activation similarity matrix described with reference to FIG. 8. Accordingly, in some cases, the hardness score H(xᵢ^{t}) provides an averaged quantification of “hardness” for the sample xᵢ^{t} (e.g., a degree of difficulty that the machine learning model f_{θ}^{s} would have learning based on the sample xᵢ^{t}) compared to the source dataset [symbol] ₛ, based on activation sizes for the source dataset [symbol] ₛ and the target dataset [symbol] ₜ, the layers of the machine learning model f_{θ}^{s}, and the number of samples in the source dataset [symbol] ₛ.

According to some aspects, the selection component determines the hard subset [symbol] _{H} is by selecting one or more samples of the target dataset [symbol] ₜ respectively corresponding to a highest similarity score or similarity scores.

According to some aspects, the selection component sorts the samples of the target dataset [symbol] ₜ into a set of non-overlapping bins, where each sample is selected for a bin based on a corresponding hardness score:

$${𝒟}_{t} = \{ {𝒟}_{t}^{{q}_{1}} , {𝒟}_{t}^{{q}_{2}} , … , {𝒟}_{t}^{{q}_{ℬ}} \} \qquad ( 2 )$$

In some cases, {q₁, q₂, . . . , q_{β}} denotes the indices of the bins, where [symbol] ₜ^{q}^{₁} denotes a bin including a sample that corresponds to a highest hardness score and [symbol] ₜ^{q}^{_{β}} denotes a bin including a sample that corresponds to a lowest hardness score. According to some aspects, the hardest bin [symbol] ₜ^{q}^{₁} is selected as the hard subset [symbol] _{H}. In some cases, a number of samples in each bin is determined based on a percentage of the number of samples in the target dataset [symbol] ₜ.

At operation 715, the system computes a transferability metric [symbol] ^{s→t} for the target dataset [symbol] ₜ based on the hard subset [symbol] _{H} of the target dataset [symbol] ₜ. In some cases, the operations of this step refer to, or may be performed by, a transferability component as described with reference to FIGS. 2-4.

In some cases, a transferability metric [symbol] ^{s→t} correlates with an accuracy [symbol] ^{s→t} of a target machine learning model f_{θ}^{s→t} (e.g., a fine-tuned machine learning model that is fine-tuned on the target dataset [symbol] ₜ) when the target machine learning model f_{θ}^{s→t} is initialized using weights of the machine learning model f_{θ}^{s} and is evaluated on an unseen target test dataset [symbol] ₜ^{test}.

In some cases, for example, the machine learning model f_{θ}^{s} outputs softmax scores over a source dataset label space [symbol] . In some cases, a “source label distribution” of the target dataset is constructed over the source label space [symbol] by passing the target dataset through the source model f_{θ}^{s}. The source label distribution can be used to build an empirical joint distribution over the source label space [symbol] and a target label space [symbol] for the target dataset [symbol] ₜ:

$$\hat{P} ( y , z ) = \frac{1}{n} {\sum }_{i : {y}_{i} = y} {{f}_{θ}^{s} ( {x}_{i} )}_{z} \qquad ( 3 )$$

In some cases, f_{θ}^{s}(xᵢ)_{z} represents a softmax score for a given target instance xᵢ for class z∈ [symbol] in the source label space [symbol] . Subsequently, an empirical conditional distribution and a marginal distribution can be computed using:

$$\hat{P} ( z ) = {\sum }_{y ∈ 𝒴} \hat{P} ( y , z ) = \frac{1}{n} {\sum }_{i = 1}^{n} {{f}_{θ}^{s} ( {x}_{i} )}_{z} \qquad ( 4 )$$

$$\hat{P} ( y \vert z ) = \frac{\hat{P} ( y , z )}{\hat{P} ( z )} \qquad ( 5 )$$

The transferability metric [symbol] ^{s→t} allows the computational expense of determining the accuracy [symbol] ^{s→t} by training the target machine learning model f_{θ}^{s→t} to be avoided. In some cases, the transferability component computes the transferability metric [symbol] ^{s→t} by substituting samples included in the hard subset [symbol] _{H} for samples included in the target dataset [symbol] ₜ in a transferability metric algorithm:

$${𝒯}^{s \to t} = T ( {f}_{θ}^{s} , {ℬ}_{H} ) \qquad ( 6 )$$

In some cases, T(·) represents any algorithm for calculating a transferability metric. Examples algorithms T(·) for calculating a transferability metric [symbol] ^{s→t} include Log Expected Empirical Prediction (LEEP) and variants MS-LEEP and E-LEEP, determining a negative conditional entropy between source and target labels, and Gaussian Bhattacharyya Coefficient (GBC). By computing the transferability metric [symbol] ^{s→t} based on the hard subset [symbol] _{H} rather than the target dataset [symbol] ₜ, the transferability component uses samples that are more correlated to the accuracy [symbol] ^{s→t} when computing the transferability metric [symbol] ^{s→t}, thereby providing a better estimation about transfer learning on the target dataset [symbol] ₜ.

As an example, in some cases, the transferability component computes the transferability metric [symbol] ^{s→t} using LEEP, which provides an average log likelihood of the machine learning model f_{θ}^{s} where the machine learning model f_{θ}^{s} predicts a target label y by directly drawing a label from a distribution p(y|x; f_{θ}^{s}, f_{H})=Σ_{z∈Z}\hat{P}(y|z) f_{θ}^{s}(x)_{z}:

$${𝒯}^{s \to t} = T ( {f}_{θ}^{s} , {ℬ}_{H} ) = \frac{1}{n} {\sum }_{i = 1}^{n} log ( {\sum }_{z ∈ 𝒵} \hat{P} ( y \vert z ) {{f}_{θ}^{s} ( x )}_{z} ) \qquad ( 7 )$$

According to some aspects, the transferability component compares the transferability metric [symbol] ^{s→t} to a transferability threshold. In some cases, when the transferability component determines that the transferability metric [symbol] ^{s→t} exceeds the transferability threshold, the transferability component therefore determines that the machine learning model f_{θ}^{s} is an appropriate candidate for transfer learning and provides the machine learning model f_{θ}^{s} to a training component as described with reference to FIGS. 2 and 4 to be trained on the target dataset [symbol] ₜ.

In some cases, when the transferability component determines that the transferability metric [symbol] ^{s→t} does not exceed the transferability threshold, the transferability component therefore determines that the machine learning model f_{θ}^{s} is not an appropriate candidate for transfer learning and does not provide the machine learning model f_{θ}^{s} to the training component as described with reference to FIGS. 2 and 4 to be trained on the target dataset [symbol] ₜ.

At operation 720, the system trains the machine learning model f_{θ}^{s} using the target dataset [symbol] ₜ based on the transferability metric [symbol] ^{s→t}. In some cases, the operations of this step refer to, or may be performed by, a training component as described with reference to FIGS. 2, 4, and 5.

In some cases, training a machine learning model refers to a process of updating parameters of the machine learning model. In some cases, the training is a supervised process. Supervised learning involves learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

A “loss function” refers to a function that impacts how a machine learning model is trained in a supervised learning model. Specifically, during each training iteration, the output of the model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

In some cases, the training is an unsupervised (or a self-supervised) process. Unsupervised learning draws inferences from datasets consisting of input data without labeled responses. Unsupervised learning may be used to find hidden patterns or grouping in data. For example, cluster analysis is a form of unsupervised learning. Clusters may be identified using measures of similarity such as Euclidean or probabilistic distance.

In some cases, the training is a reinforcement learning process. Reinforcement learning relates to how software agents make decisions in order to maximize a reward. The decision making model may be referred to as a policy. Reinforcement learning differs from supervised learning in that labelled training data might not be used, and errors might not be explicitly corrected. Instead, reinforcement learning balances exploration of unknown options and exploitation of existing knowledge. In some cases, the reinforcement learning environment is stated in the form of a Markov decision process (MDP). Furthermore, many reinforcement learning algorithms utilize dynamic programming techniques. However, one difference between reinforcement learning and other dynamic programming methods is that reinforcement learning does not require an exact mathematical model of the MDP. Therefore, reinforcement learning models may be used for large MDPs where exact methods are impractical.

According to some aspects, in response to the determination by the transferability component, the training component trains the machine learning model f_{θ}^{s} using the target dataset [symbol] ₜ by updating parameters of the machine learning model f_{θ}^{s} with respect to the target dataset [symbol] ₜ via a transfer learning process. For example, in some cases, the training component fine-tunes the machine learning model f_{θ}^{s} by replacing a final source classification layer of the machine learning model f_{θ}^{s} with a target classification layer, and then training the machine learning model f_{θ}^{s} on the target dataset [symbol] ₜ. In some cases, the training component performs a head re-training process by freezing weights of all layers of the machine learning model f_{θ}^{s} except for a final classification layer, initializing the final classification layer using the target label space [symbol] , and training the final classification layer from scratch on the target dataset [symbol] ₜ.

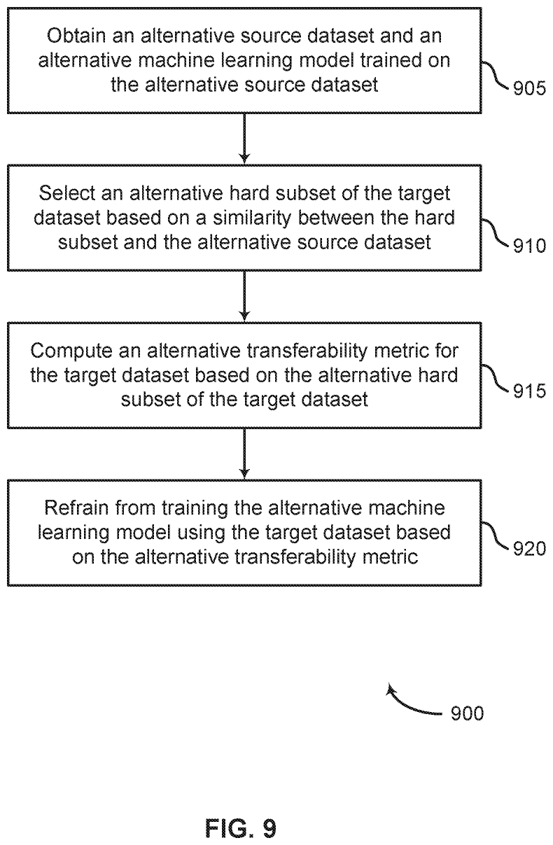

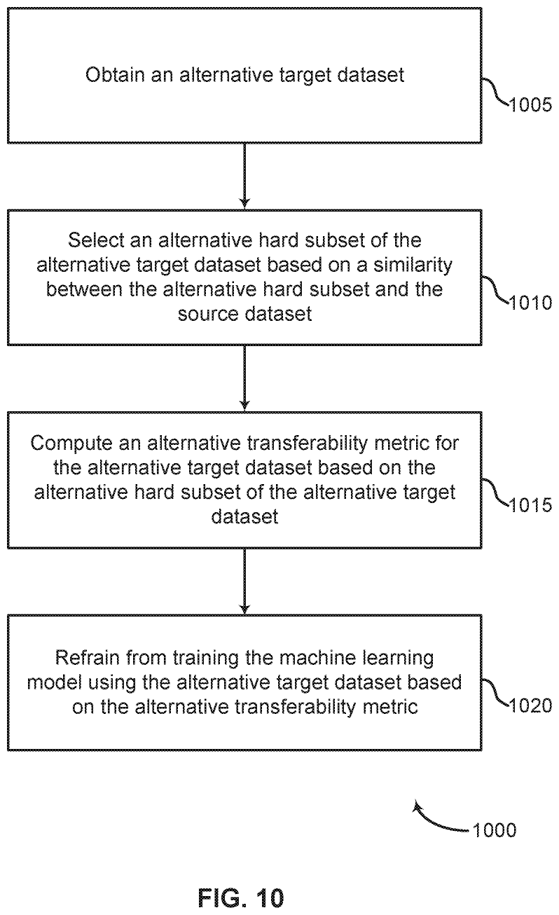

An example of an embodiment in which the data processing apparatus refrains from training an alternative machine learning model is described with reference to FIG. 9. An example of an embodiment in which the data processing apparatus refrains from training the machine learning model f_{θ}^{s} using an alternate target dataset is described with reference to FIG. 10.

FIG. 8 shows an example of a method 800 for computing a similarity score according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 8, a selection component described with reference to FIGS. 2 and 3 computes a similarity score, where the hard subset a is selected as described with reference to FIG. 7 based on the similarity score.

At operation 805, the system computes an intermediate target embedding for a sample xᵢ^{t} of the target dataset [symbol] ₜ using the machine learning model f_{θ}^{s}. In some cases, the operations of this step refer to, or may be performed by, a selection component as described with reference to FIGS. 2 and 3. According to some aspects, the selection component computes a set of intermediate target embeddings at a set of layers of the machine learning model f_{θ}^{s}.

At operation 810, the system computes an intermediate source embedding for a sample xᵢ^{s} of the source dataset [symbol] ₛ using the machine learning model f_{θ}^{s}. In some cases, the operations of this step refer to, or may be performed by, a selection component as described with reference to FIGS. 2 and 3. According to some aspects, the selection component computes a set of intermediate source embeddings at the set of layers of the machine learning model f_{θ}^{s}.

At operation 815, the system computes a similarity score s(xᵢ^{s}, xᵢ^{t}) based on the intermediate target embedding and the intermediate source embedding. In some cases, the operations of this step refer to, or may be performed by, a selection component as described with reference to FIGS. 2 and 3. In some cases, the similarity score is a cosine similarity. In some cases, the selection component computes the similarity score s(xᵢ^{s}, xᵢ^{t}) based on the set of intermediate source embeddings and the set of intermediate target embeddings:

$$s ( {x}_{i}^{s} , {x}_{i}^{t} ) = \frac{1}{L} {\sum }_{l = 1}^{L} {ε}_{l} ( {x}_{i}^{s} ) \cdot {ε}_{l} ( {x}_{i}^{t} ) \qquad ( 8 )$$

In some cases, s(·) denotes a cosine similarity, εₗ(·) is an activation size of an l^{th} layer of the machine learning model f_{θ}^{s} (e.g., a product of a width, a height, and a number of channels of the l^{th} layer), and L is a total number of layers of the machine learning model f_{θ}^{s}. Accordingly, in some cases, the selection component computes a similarity between activation sizes of a source sample xᵢ^{s} and a target sample xᵢ^{t}. In some cases, the selection component calculates a pairwise activation similarity matrix S∈ [symbol] ^{m×n} for the source dataset [symbol] ₛ and the target dataset [symbol] ₜ using the similarity score s(xᵢ^{s}, xᵢ^{t}).

At operation 820, the system selects the hard subset [symbol] _{H} based on the similarity score s(xᵢ^{s}, xᵢ^{t}). In some cases, the operations of this step refer to, or may be performed by, a selection component as described with reference to FIGS. 2 and 3. For example, in some cases, the selection component selects the hard subset based on the similarity score s(xᵢ^{s}, xᵢ^{t}) as described with reference to FIG. 7.

FIG. 9 shows an example of a method 900 for refraining from training an alternative machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 9, in an embodiment, the data processing apparatus described with reference to FIGS. 1-3 decides not to train an alternate machine learning model for an alternate source dataset using the target dataset [symbol] ₜ.

At operation 905, the system obtains an alternative source dataset and an alternative machine learning model trained on the alternative source dataset. In some cases, the operations of this step refer to, or may be performed by, a selection component as described with reference to FIGS. 2 and 3. In some cases, the alternative source dataset and the alternative machine learning model are obtained in a similar manner to the source dataset [symbol] ₛ and the machine learning model f_{θ}^{s} as described with reference to FIG. 7.

At operation 910, the system selects an alternative hard subset of the target dataset [symbol] ₜ based on a similarity between the alternative hard subset and the alternative source dataset. In some cases, the operations of this step refer to, or may be performed by, a selection component as described with reference to FIGS. 2 and 3. For example, in some cases, the selection component obtains the alternative hard subset based on a comparison between the target dataset [symbol] ₜ and the alternative source dataset that is performed in a similar manner as the comparison of the target dataset [symbol] ₜ and the source dataset [symbol] ₛ as described with reference to FIG. 7.

At operation 915, the system computes an alternative transferability metric for the target dataset [symbol] ₜ based on the alternative hard subset of the target dataset [symbol] ₜ. In some cases, the operations of this step refer to, or may be performed by, a transferability component as described with reference to FIGS. 2-4. For example, in some cases, the transferability component computes the alternative transferability metric for the target dataset [symbol] ₜ in a similar manner as the computation of the transferability metric [symbol] ^{s→t} as described with reference to FIG. 7.

At operation 920, the system refrains from training the alternative machine learning model using the target dataset [symbol] ₜ based on the alternative transferability metric. In some cases, the operations of this step refer to, or may be performed by, a training component as described with reference to FIGS. 2, 4, and 5.

For example, in some cases, the transferability component compares the alternative transferability metric to the transferability threshold as described with reference to FIG. 7 and determines that the alternative transferability metric does not exceed the transferability threshold. In response to the determination, the training component refrains from training the alternative machine learning model. For example, in some cases, the transferability component does not send the alternative machine learning model to the training component. For example, in some cases, the transferability component sends a signal instructing the training component not to train the alternative machine learning model.

FIG. 10 shows an example of a method 1000 for refraining from training a machine learning model based on an alternative target dataset according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 10, in an embodiment, the data processing apparatus described with reference to FIGS. 1-3 decides not to train the machine learning model f_{θ}^{s} using an alternate target dataset.

At operation 1005, the system obtains an alternative target dataset. In some cases, the operations of this step refer to, or may be performed by, a selection component as described with reference to FIGS. 2 and 3. In some cases, the alternative source target dataset is obtained in a similar manner to the target dataset [symbol] _{T} as described with reference to FIG. 7.

At operation 1010, the system selects an alternative hard subset of the alternative target dataset based on a similarity between the alternative hard subset and the source dataset [symbol] ₛ. In some cases, the operations of this step refer to, or may be performed by, a selection component as described with reference to FIGS. 2 and 3. For example, in some cases, the selection component obtains the alternative hard subset based on a comparison between the alternative target dataset and the source dataset [symbol] ₛ that is performed in a similar manner as the comparison of the target dataset [symbol] ₜ and the source dataset [symbol] ₛ as described with reference to FIG. 7.

At operation 1015, the system computes an alternative transferability metric for the alternative target dataset based on the alternative hard subset of the alternative target dataset. In some cases, the operations of this step refer to, or may be performed by, a transferability component as described with reference to FIGS. 2-4. For example, in some cases, the transferability component computes the alternative transferability metric for the alternative target dataset in a similar manner as the computation of the transferability metric [symbol] ^{s→t} as described with reference to FIG. 7

At operation 1020, the system refrains from training the machine learning model f_{θ}^{s} using the alternative target dataset based on the alternative transferability metric. In some cases, the operations of this step refer to, or may be performed by, a training component as described with reference to FIGS. 2, 4, and 5. For example, in some cases, the transferability component compares the alternative transferability metric to the transferability threshold as described with reference to FIG. 7 and determines that the alternative transferability metric does not exceed the transferability threshold. In response to the determination, the training component refrains from training the machine learning model f_{θ}^{s} using the alternative target dataset. For example, in some cases, the transferability component does not send the machine learning model f_{θ}^{s} to the training component. For example, in some cases, the transferability component sends a signal instructing the training component not to train the machine learning model f_{θ}^{s} using the alternative target dataset.

### Label Generation

A transfer learning method is described with reference to FIG. 11. One or more aspects of the method include obtaining input data in a target domain; identifying a machine learning model for the target domain, wherein the machine learning model is trained on a source dataset of a source domain and fine-tuned on a target dataset of the target domain, and wherein the machine learning model is fine-tuned based on a transferability metric computed based on a hard subset of the target dataset; and generating a label for the input data using the machine learning model.

Some examples of the method further include computing an intermediate target embedding for a sample of the target dataset using the machine learning model. Some examples further include computing an intermediate source embedding for a sample of the source dataset using the machine learning model. Some examples further include computing a similarity score based on the intermediate target embedding and the intermediate source embedding, wherein the hard subset is identified based on the similarity score. Some examples of the method further include computing a plurality of intermediate target embeddings at a plurality of layers of the machine learning model, wherein the similarity score is based on the plurality of intermediate target embeddings.

Some examples of the method further include computing a hardness score for each sample of the target dataset, wherein the hard subset is identified based on the hardness score. Some examples of the method further include calculating a pairwise activation similarity matrix between a plurality of target samples of the target dataset and a plurality of source samples of the source dataset, wherein the hardness score is based on the pairwise activation similarity matrix.

Some examples of the method further include sorting the target dataset into a plurality of non-overlapping bins. Some examples further include selecting the hard subset based on the plurality of non-overlapping bins. Some examples of the method further include determining that the transferability metric is greater than a transferability threshold, wherein the machine learning model is fine-tuned based on the determination.

FIG. 11 shows an example of a method 1100 for generating a label according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, an example of a data processing system as described with reference to FIGS. 1-5 identifies a machine learning model as a candidate for transfer learning based on a hard subset of a target dataset, fine-tunes the machine learning model using the target dataset based on the identification, and generates a label for input data using the fine-tuned machine learning model.

At operation 1105, the system obtains input data in a target domain. In some cases, the operations of this step refer to, or may be performed by, a classification component as described with reference to FIGS. 2 and 5. In some cases, a user (such as the user described with reference to FIG. 1) provides the input data to the classification component. In some cases, the selection component retrieves the input data from a database (such as the database described with reference to FIGS. 1 and 2). In some cases, the classification component retrieves the input data in response to a command from the user. In some cases, the input data is in a same target domain as the target dataset (such as the target dataset [symbol] ₜ described with reference to FIG. 7).

At operation 1110, the system identifies a machine learning model f_{θ}^{s→t} for the target domain, where the machine learning model f_{θ}^{s→t} is trained on a source dataset of a source domain (such as the source dataset [symbol] ₛ described with reference to FIG. 7) and fine-tuned on the target dataset of the target domain, and where the machine learning model is fine-tuned based on a transferability metric computed based on a hard subset of the target dataset. In some cases, the operations of this step refer to, or may be performed by, a classification component as described with reference to FIGS. 2 and 5.

For example, in some cases, the data processing apparatus fine-tunes a machine learning model f_{θ}^{s} for a source dataset using the target dataset based on a determination corresponding to a hard subset of the target dataset as described with reference to FIG. 7. In some cases, the training component described with reference to FIGS. 2 and 4 stores the fine-tuned machine learning model fort in a database (such as the database described with reference to FIGS. 1 and 2). In some cases, the training component stores an association between the target domain corresponding to the target dataset and the fine-tuned machine learning model f_{θ}^{s→t} in the database. In some cases, in response to receiving the input data, the classification component retrieves the fine-tuned machine learning model f_{θ}^{s→t} from the database based on the association between the target domain corresponding to the input data and the fine-tuned machine learning model f_{θ}^{s→t}.

At operation 1115, the system generates a label for the input data using the fine-tuned machine learning model f_{θ}^{s→t}. In some cases, the operations of this step refer to, or may be performed by, a classification component as described with reference to FIGS. 2 and 5. For example, in some cases, the classification component provides the input data to the fine-tuned machine learning model. Based on the fine-tuning, the fine-tuned machine learning model f_{θ}^{s→t} provides the label for the input data. In some cases, the classification component provides the label to the user (for example, via a user device as described with reference to FIG. 1).

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for transfer learning, comprising:
obtaining a target dataset, a source dataset, and a machine learning model trained on the source dataset;
selecting a hard subset of the target dataset based on a similarity between the hard subset and the source dataset;
computing a transferability metric for the target dataset based on the hard subset of the target dataset; and
training the machine learning model using the target dataset based on the transferability metric.

2. The method of claim 1, further comprising:
computing an intermediate target embedding for a sample of the target dataset using the machine learning model;
computing an intermediate source embedding for a sample of the source dataset using the machine learning model; and
computing a similarity score based on the intermediate target embedding and the intermediate source embedding, wherein the hard subset is selected based on the similarity score.

3. The method of claim 2, further comprising:
computing a plurality of intermediate target embeddings at a plurality of layers of the machine learning model, wherein the similarity score is based on the plurality of intermediate target embeddings.

4. The method of claim 1, further comprising:
computing a hardness score for each sample of the target dataset, wherein the hard subset is selected based on the hardness score.

5. The method of claim 4, further comprising:
calculating a pairwise activation similarity matrix between a plurality of target samples of the target dataset and a plurality of source samples of the source dataset, wherein the hardness score is based on the pairwise activation similarity matrix.

6. The method of claim 1, further comprising:
sorting the target dataset into a plurality of non-overlapping bins; and
selecting the hard subset based on the plurality of non-overlapping bins.

7. The method of claim 1, further comprising:
determining that the transferability metric is greater than a transferability threshold, wherein the machine learning model is trained using the target dataset based on the determination.

8. The method of claim 1, further comprising:
obtaining an alternative source dataset and an alternative machine learning model trained on the alternative source dataset;
selecting an alternative hard subset of the target dataset based on a similarity between the hard subset and the alternative source dataset;
computing an alternative transferability metric for the target dataset based on the alternative hard subset of the target dataset; and
refraining from training the alternative machine learning model using the target dataset based on the alternative transferability metric.

9. The method of claim 1, further comprising:
obtaining an alternative target dataset;
selecting an alternative hard subset of the alternative target dataset based on a similarity between the alternative hard subset and the source dataset;
computing an alternative transferability metric for the alternative target dataset based on the alternative hard subset of the alternative target dataset; and
refraining from training the machine learning model using the alternative target dataset based on the alternative transferability metric.

10. The method of claim 1, wherein:
the target dataset represents a different domain than the source dataset.

11. A method for transfer learning, comprising:
obtaining input data in a target domain;
identifying a machine learning model for the target domain, wherein the machine learning model is trained on a source dataset of a source domain and fine-tuned on a target dataset of the target domain, and wherein the machine learning model is fine-tuned based on a transferability metric computed based on a hard subset of the target dataset; and
generating a label for the input data using the machine learning model.

12. The method of claim 11, further comprising:
computing an intermediate target embedding for a sample of the target dataset using the machine learning model;
computing an intermediate source embedding for a sample of the source dataset using the machine learning model; and
computing a similarity score based on the intermediate target embedding and the intermediate source embedding, wherein the hard subset is identified based on the similarity score.

13. The method of claim 12, further comprising:
computing a plurality of intermediate target embeddings at a plurality of layers of the machine learning model, wherein the similarity score is based on the plurality of intermediate target embeddings.

14. The method of claim 11, further comprising:
computing a hardness score for each sample of the target dataset, wherein the hard subset is identified based on the hardness score.

15. The method of claim 14, further comprising:
calculating a pairwise activation similarity matrix between a plurality of target samples of the target dataset and a plurality of source samples of the source dataset, wherein the hardness score is based on the pairwise activation similarity matrix.

16. The method of claim 11, further comprising:
sorting the target dataset into a plurality of non-overlapping bins; and
selecting the hard subset based on the plurality of non-overlapping bins.

17. The method of claim 11, further comprising:
determining that the transferability metric is greater than a transferability threshold, wherein the machine learning model is fine-tuned based on the determination.

18. An apparatus for transfer learning, comprising:
at least one processor;
a memory storing instructions executable by the at least one processor;
a selection component configured to select a hard subset of a target dataset based on a similarity between the hard subset and a source dataset used to train a machine learning model; and
a transferability component configured to compute a transferability metric for the target dataset and the machine learning model based on the hard subset of the target dataset.

19. The apparatus of claim 18, further comprising:
a training component configured to train the machine learning model using the target dataset based on the transferability metric.

20. The apparatus of claim 18, further comprising:
a database configured to store the target dataset and the source dataset.
